(19) United States
(12) Patent Application Publication
(10) Pub. No.: US 2026/0258541 A1
(43) Pub. Date: Sep. 3, 2026

(54) METHOD FOR HEATING STEEL SHEET, METHOD FOR PRODUCING COATED STEEL SHEET, DIRECT FIRED FURNACE, AND CONTINUOUS HOT-DIP GALVANIZING FACILITY

(71) Applicant: JFE Steel Corporation, Chiyoda-ku, Tokyo (JP)

(72) Inventors: Yu TERASAKI, Chiyoda-ku, Tokyo (JP); Kenichi OSUKA, Chiyoda-ku, Tokyo (JP); Gentaro TAKEDA, Chiyoda-ku, Tokyo (JP)

(73) Assignee: JFE Steel Corporation, Chiyoda-ku, Tokyo (JP)

(21) Appl. No.: 18/879,453

(22) PCT Filed: Jul. 5, 2023
(86) PCT No.: PCT/JP2023/024886

§ 371 Date: Dec. 27, 2024

(30) Foreign Application Priority Data
Jul. 12, 2022 (JP) 2022-111550

(51) Int. Cl. C23C 2/02; C22C 38/00; C22C 38/02; C22C 38/04; C22C 38/06; C22C 38/20; C22C 38/22; C22C 38/26; C23C 2/00; C23C 2/28; C23C 2/40; F27B 9/38

(52) U.S. Cl. CPC C23C 2/0222; C22C 38/001; C22C 38/002; C22C 38/02; C22C 38/04; C22C 38/06; C22C 38/20; C22C 38/22; C22C 38/26; C23C 2/0038; C23C 2/285; C23C 2/40; F27B 9/38

(57) ABSTRACT

A galvanized steel sheet is disclosed. A method for heating a steel sheet includes heating a front surface side and a rear surface side of a steel sheet that is passing through a direct fired furnace that has an oxidation zone where operation is conducted at an air ratio of 1 or more and a reduction zone where operation is conducted at an air ratio of less than 1, in which the heating is carried out with flames injected from at least one slit burner extending in the width direction of the steel sheet while the steel sheet passes through at least the reduction zone.

### CROSS REFERENCE TO RELATED APPLICATIONS

This is the U.S. National Phase application of PCT/JP2023/024886, filed Jul. 5, 2023 which claims priority to Japanese Patent Application No. 2022-111550, filed Jul. 12, 2022, the disclosures of these applications being incorporated herein by reference in their entireties for all purposes.

### FIELD OF THE INVENTION

The present invention relates to a method for heating a steel sheet, a method for producing a coated steel sheet, a direct fired furnace, and a continuous hot-dip galvanizing facility using a direct fired furnace.

### BACKGROUND ART

Solid-solution strengthening elements such as Si, Mn, P, and Al are often added to increase the tensile strength of steel sheets. In particular, Si offers advantages in that the cost for addition is low compared to other elements and that the strength can be increased without degrading the ductility of the steel. Thus, Si-containing steel is considered promising as high tensile strength steel sheets. However, the following problems arise when a large amount of Si is contained in the steel.

A high tensile strength steel sheet is annealed in a 600° C. to 900° C. temperature range in a reducing atmosphere in a step immediately preceding a coating step such as a hot-dip galvanizing step. Since Si is more easily oxidizable than Fe, Si concentrates in the steel sheet surface during this process. As a result, Si oxides form in the steel sheet surface and extensively degrade wettability with zinc, thereby causing bare spot. Furthermore, the concentration of Si in the surface extensively delays alloying in the alloying process following the hot-dip galvanization even if a galvanized coating has adhered, resulting in degraded productivity.

A well known technique that addresses these problems is a technique of improving wettability with zinc by heating a steel sheet in an oxidation zone where direct firing burners are installed to form an oxide film on the steel sheet surface, then reducing a part (surface layer) of the oxide film in the steel sheet surface in a reduction zone to form reduced Fe, and then further reducing the oxide film in a subsequent reduction annealing zone. In particular, when the oxide film formed in the reduction zone is not sufficiently reduced, oxide scales adhere to the furnace rolls, and a what is known as a pickup phenomenon, which is occurrence of press marks (roll marks) on the steel sheet, occurs. Thus, techniques for maintaining performance of the reduction zone uniform have been disclosed.

For example, there has been disclosed techniques of preventing pickups by adjusting the atmosphere gas concentrations in the oxidation zone, the reduction zone, and the reduction annealing zone in a direct fired furnace (DFF) or a non-oxidizing furnace (NOF).

For example, Patent Literature 1 discloses a technique of performing an oxidation treatment, then reduction annealing, and then a hot-dip galvanizing treatment. Specifically, in this oxidation treatment, heating is performed at a temperature of 400° C. or higher and 750° C. or lower at an O₂ concentration of 1000 volume ppm or more and a H₂O concentration of 1000 volume ppm or more in a first stage. Subsequently, in a second stage, heating is performed at a temperature of 600° C. or higher and 850° C. or lower at an O₂ concentration of less than 1000 volume ppm and a H₂O concentration of 1000 volume ppm or more. However, for example, in the case of conventional burners that have circular burner nozzle exits disclosed in Patent Literatures 2 and 3, the thickness of the reduced Fe in the surface layer cannot be uniformly controlled even when these burners are dispersedly distributed such as in a staggered pattern, resulting in pickups. Meanwhile, Patent Literature 4 has proposed a method of using slit burners in an oxidation zone of a horizontal furnace to achieve uniformity in the sheet width direction, in which these slit burners have a burner nozzle exit shape parallel to the steel sheet width direction. However, when slit burners are installed only in the oxidation zone and slit burners are installed in an oxidizing furnace placed after a non-oxidizing furnace, the oxidizing furnace atmosphere flows into the non-oxidizing furnace since the furnace is of a horizontal type, thereby creating sheet temperature variation and nonuniformity in the Fe oxide film, and thus the effect of making flames uniform in the width direction by using slit burners is not obtained.

### PATENT LITERATURE

Patent Literature 1: Japanese Patent No. 6323628
Patent Literature 2: Japanese Unexamined Patent Application Publication No. 62-29820
Patent Literature 3: Japanese Unexamined Patent Application Publication No. 9-59753
Patent Literature 4: Japanese Patent No. 3889019

### SUMMARY OF THE INVENTION

Aspects of the present invention have been made in view of the aforementioned problems and an object thereof is to produce a galvanized steel sheet with stable quality free of pickups by a relatively simple method suitable for practical applications.

Aspects of the present invention were made to resolve the aforementioned problems and include the following features.
[1]A method for heating a steel sheet, the method including heating a front surface side and a rear surface side of a steel sheet that is passing through a direct fired furnace that has an oxidation zone where operation is conducted at an air ratio of 1 or more and a reduction zone where operation is conducted at an air ratio of less than 1, wherein the heating is carried out with flames injected from at least one slit burner extending in a width direction of the steel sheet while the steel sheet passes through at least the reduction zone.
[2] The method for heating a steel sheet described in [1], in which the direct fired furnace conveys the steel sheet in a vertical direction and suctions combustion exhaust gas from an exhaust port installed under the slit burner.
[3] The method for heating a steel sheet described in [1] or [2],
   in which the air ratio in the oxidation zone is controlled to 1.00 or more and less than 1.50, and
   the air ratio in the reduction zone is controlled to 0.70 or more and less than 1.00.
[4]A method for producing a coated steel sheet, the method including heat-treating a cold rolled steel sheet by the heating method described in any one of [1] to [3] described above, and subjecting the cold rolled steel sheet to a coating treatment.
[5] The method for producing a coated steel sheet described in [4], in which the coating treatment uses one of an electrogalvanizing treatment, a hot-dip galvanizing treatment, and a galvannealing treatment.
[6]A direct fired furnace including:
   an oxidation zone where operation is conducted at an air ratio of 1 or more, a reduction zone where operation is conducted at an air ratio of less than 1, and a control device capable of controlling the air ratios in the oxidation zone and the reduction zone,
   in which at least one portion of the reduction zone is equipped with:
   at least one slit burner disposed on a front surface side of the steel sheet and at least one slit burner disposed on a rear surface side of the steel sheet, each of the slit burners extending in a width direction of the steel sheet and injecting flames toward the steel sheet passing through the oxidation zone and the reduction zone.
[7] The direct fired furnace described in [6], in which the steel sheet is conveyed in a vertical direction, and combustion exhaust gas is suctioned from an exhaust port installed under the slit burners.
[8] The direct fired furnace described in [6] or [7], in which the air ratio in the oxidation zone is controlled to 1.00 or more and less than 1.50, and the air ratio in the reduction zone is controlled to 0.70 or more and less than 1.00.
[9]A continuous hot-dip galvanizing facility including the direct fired furnace described in any one of [6] to [8] described above.
[10] The continuous hot-dip galvanizing facility described in [9], further including an alloying facility that alloys hot-dip galvanized coatings.

According to aspects of the present invention, an excellent galvanized steel sheet having beautiful surface appearance with reduced bare spot and free of pickups is obtained. Aspects of the present invention are particularly effective when a high-Si-content steel sheet, which is particularly difficult to galvanize, is used as the base material, and is useful as a method for improving the coating quality in the production of high-Si-content galvanized steel sheets.

### BRIEF DESCRIPTION OF DRAWINGS

FIG. 1 illustrates one embodiment of a direct fired furnace installed in a continuous hot-dip galvanizing apparatus according to an embodiment of the present invention, in which (a) is a vertical sectional view of the direct fired furnace and (b) is a front view of an arrangement example of direct firing burners installed in walls of the direct fired furnace.

FIG. 2 is a diagram illustrating one example of a continuous hot-dip galvanizing facility according to an embodiment of the present invention.

FIG. 3 is a diagram conceptually illustrating the state of an actual steel sheet being combustion-heated with slit burners according to an embodiment of the present invention.

FIG. 4 is a diagram illustrating one example of the structure of the direct fired furnace according to an embodiment of the present invention.

### DETAILED DESCRIPTION OF EMBODIMENTS OF THE INVENTION

A direct fired furnace that heats a steel sheet by using direct firing burners has high heat efficiency and is thus characterized by its ability to heat steel sheets to a particular temperature at a low cost. With a direct fired furnace, it is necessary to control the temperature of the steel sheet and, when high tensile strength steel such as high-Si steel is to be hot-dip galvanized, to control the atmosphere of the direct firing burners to an oxidizing atmosphere. In this manner, after an appropriate oxide film (Fe oxides) is securely obtained in the steel sheet surface, a part of the surface layer of the Fe oxides is reduced with the reduced Fe by controlling the atmosphere of the direct firing burner second stage to a reductive atmosphere, and reduced Fe is further formed in the subsequent reduction annealing zone to prevent pickups.

However, in the case of conventional burners that have circular burner nozzle exits, the thickness of the reduced Fe in the surface layer cannot be uniformly controlled in the steel sheet travelling direction and width direction even when these burners are dispersedly distributed such as in a staggered pattern, resulting in pickups.

Aspects of the present invention include a method of controlling the thickness of the reduced Fe uniformly in the steel sheet travelling direction and width direction by using slit burners in a reduction zone.

In the description below, a direct fired furnace installed in a continuous hot-dip galvanizing facility and a method for heating a steel sheet according to embodiments of the present invention are described with reference to the drawings.

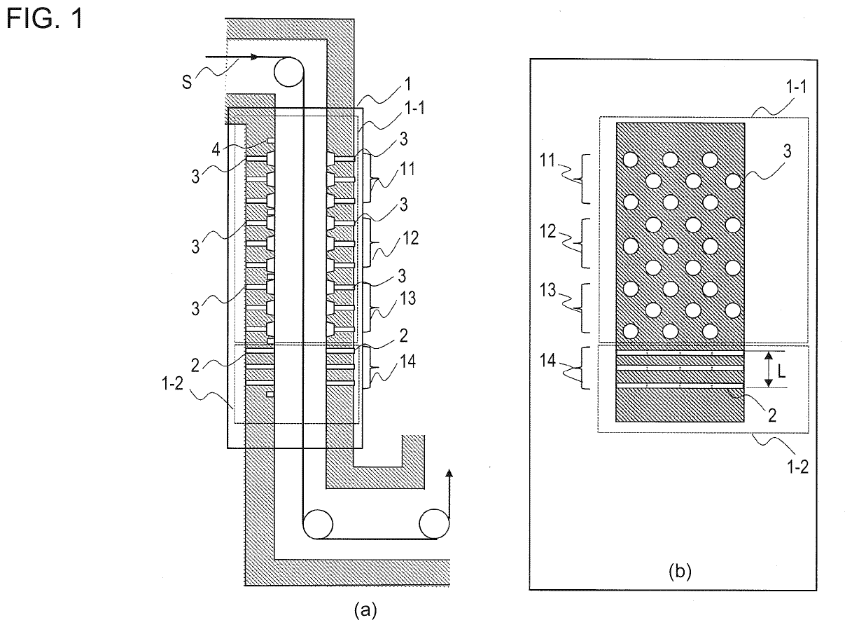

FIG. 1 illustrates one embodiment of a direct fired furnace (DFF) installed in an annealing facility of a continuous hot-dip galvanizing facility according to an embodiment of the present invention. Here, the type of the annealing facility is preferably a vertical furnace. In other words, it becomes possible to pass a steel sheet at a high speed by conveying the steel sheet in a vertical direction (including conveying the steel sheet while turning the steel sheet back and forth in the vertical direction) without expanding the scale of the facility in the horizontal direction. In addition, this also provides an advantage in that the atmosphere in the heating zone and the atmosphere in the soaking zone can be easily separated. Conveying in a vertical direction means that the sheet is conveyed in a perpendicular direction.

In FIG. 1, (a) is a vertical sectional view of a direct fired furnace, and (b) is a front view of an arrangement example of direct firing burners installed in walls of the direct fired furnace. In FIG. 1, 1 denotes a direct fired furnace (DFF), 1-1 denotes an oxidation zone of the DFF, 1-2 denotes a reduction zone of the DFF, 2 denotes a flame injection port associated with a slit burner, 3 denotes a flame injection port associated with a circular burner, S denotes a steel sheet (including a steel strip), 4 denotes a radiation thermometer, L denotes the length of a steel sheet S heated region heated by a burner group 14 in the reduction zone from the burner most upstream to the burner most downstream in the steel strip travelling direction, 11 denotes a burner group in the oxidation zone, 12 denotes a burner group in the oxidation zone, 13 denotes a burner group in the oxidation zone, and 14 denotes a burner group in the reduction zone. Although not illustrated in the drawings, there is also provided a control device that controls the air ratios in the oxidation zone and the reduction zone.

### <Direct Fired Furnace Installed in Continuous Hot-Dip Galvanizing Facility>

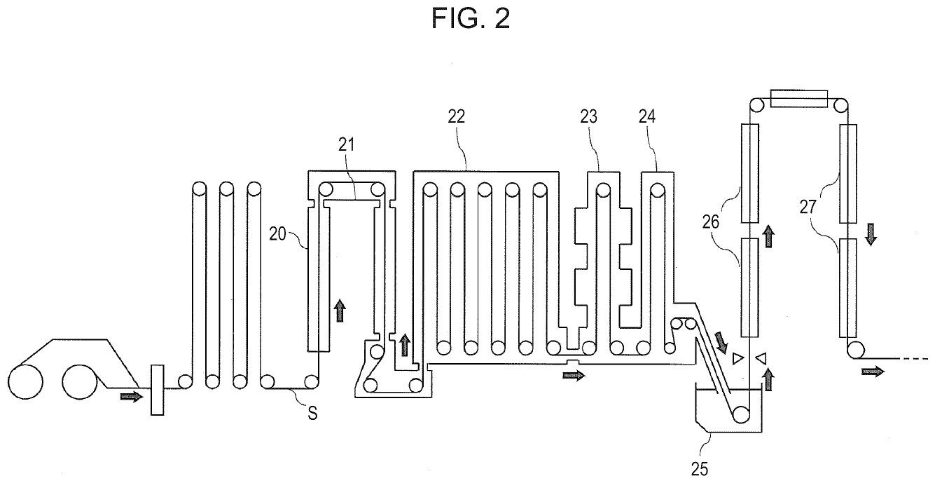

FIG. 2 illustrates one example of a continuous hot-dip galvanizing facility. From the entry side of the facility, there are provided a preheating zone 20, a heating zone 21, a soaking zone 22, cooling zones 23 and 24, a coating bath (zinc pot) 25, and, if necessary, an alloying zone 26. A cooling zone 27 may be provided after the alloying zone 26. As such, when the heating furnace of the present application is applied to a part of the continuous hot-dip galvanizing facility, the steel sheet to be heated does not have to be a cut sheet and may have a steel strip (coil) shape. Although the steel sheet is not particularly limited, a cold rolled steel sheet is often used.

The direct fired furnace 1 according to an embodiment of the present invention is assumed as a heating furnace to be introduced in the heating zone 21 in the continuous hot-dip galvanizing facility. Here, the example illustrated in FIG. 1 is described in detail. The slit burners are arranged to face the steel sheet surfaces. Furthermore, in order to match the steel sheet width, the flame injection port is divided in four in the width direction. Although the number of divided regions here is 4, the number is not limited to 4, and there may be cases in which no division is necessary depending on the width of the steel sheet and the flame injection structures of the slit burners. Meanwhile, the circular burners are dispersedly arranged to face the steel sheet surfaces.

The direct fired furnace 1 is constituted by an oxidation zone 1-1 and a reduction zone 1-2, among which the oxidation zone 1-1 is constituted by three burner groups (zones) 11 to 13 in the steel sheet travelling direction, and circular burners are used in the burner groups 11 to 13 in the oxidation zone. The flame injection ports thereof are denoted by reference sign 3 in the drawings. The reduction zone has only one reduction zone burner group 14, and slit burners are installed therein. The flame injection ports of the slit burners are denoted by reference sign 2 in the drawings. For circular burners in the oxidation zone burner groups 11, 12, and 13 in the oxidation zone 1-1 and the slit burners in the burner group 14 in the reduction zone, the combustion rate and the air ratio of the burners can be independently controlled for each burner group. The circular burners in the burner groups 11 to 13 in the oxidation zone and the slit burners in the burner group 14 in the reduction zone are combusted under the conditions that give a combustion rate equal to or higher than a predetermined threshold.

The number of burners contained in each burner group is not limited. It is practical to divide the entire DFF into two to five and to control each as a group.

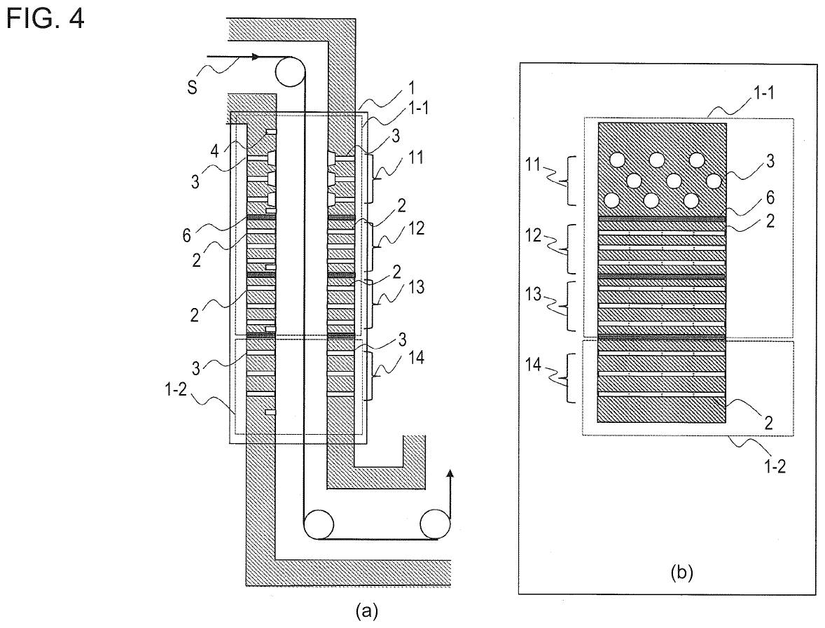

Furthermore, for example, as illustrated by the facility in FIG. 4, the slit burners may be provided not only in the reduction zone 1-2 but also in both the oxidation zone 1-1 and the reduction zone 1-2.

Here, the slit burners are arranged to face the steel sheet surfaces in the width direction of the steel sheet S passing through the reduction zone 1-2. Moreover, in order to uniformly heat the steel sheet S without variation in the width direction, the slit burners are arranged to extend in the width direction of the steel sheet so that the flames 5 are injected toward the entire width of the steel sheet S. Furthermore, in order to comply with production of steel sheets S with various widths, the flame injection amount can be controlled for each of four regions divided in the width direction. Although the number of divided regions here is 4, the number is not limited to 4, and there may be cases in which no division is necessary depending on the width of the steel sheet and the flame injection structures of the slit burners.

An annealing furnace (RT furnace), a cooling zone, a hot-dip galvanizing facility, an alloying treatment facility, etc., are placed downstream of the direct fired furnace. The RT furnace, the cooling zone, the hot-dip galvanizing facility, the alloying treatment facility, etc., are not particularly limited and may be those which are commonly employed. A preheating furnace is sometimes placed upstream of the direct fired furnace.

### <Slit Burners>

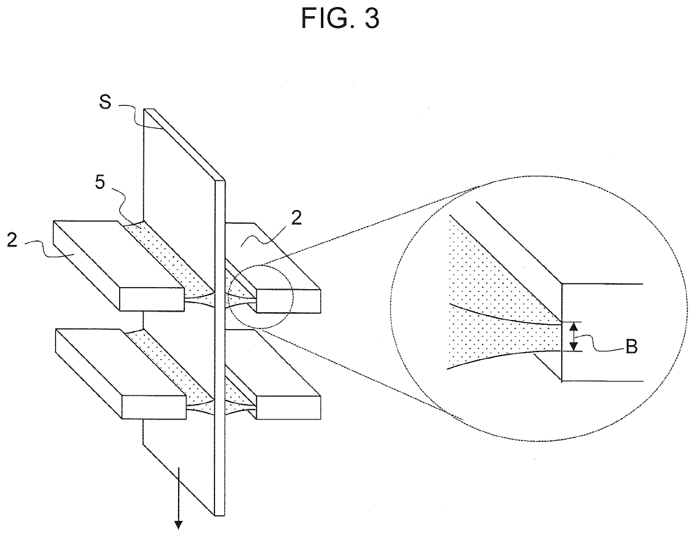

FIG. 3 is a diagram conceptually illustrating the state of an actual steel sheet being combusted and heated with slit burners according to an embodiment of the present invention, and in the description below, the slit burners are described by referring to what is illustrated in the drawing.

A slit burner refers to a burner having a burner flame injection port having an elongated rectangular shape that has a long opening portion in the width direction of the steel sheet S with respect to the length (also referred to as a slit gap B) of the opening in the steel sheet S travelling direction, and the specific dimensions thereof are not particularly limited. For example, when the length of the opening portion in the steel sheet S travelling direction, that is, the short side, is represented by B, the length of the opening portion in the width direction, that is, the long side, is about 2B to 200B. In accordance with aspects of the present invention, a burner that injects a slit-shaped flame 5, such as a burner having such a thin elongated rectangular flame injection port, is generally referred to as a “slit burner”. Thus, no limitations are particularly imposed as to the inner structure and the injection port. Furthermore, with this flame injection port, the injection width of the flame 5 can be controlled by dividing the injection port in the width direction, and this can be used to adjust the injection width of the flame 5 according to the width of the subject steel sheet.

It is effective to provide one slit burner in the steel sheet S travelling direction; however, reduction can be more efficiently carried out by arranging several slit burners in a tandem pattern. The arrangement intervals of the tandem pattern are not particularly limited; however, creating intervals of about 3B to 10B reduces interference of the flames 5 and the temperature variation.

Furthermore, placement of the flame injection ports 2 associated with the slit burners may be shifted, in other words, may be offset, in the steel sheet S travelling direction between the front and rear surfaces of the steel sheet. Offset prevents the flames 5 extending beyond the steel sheet edges from interfering with one another. Thus, it is possible to uniformly heat a larger region than when offset is not made. The offset amount is in the range of about B to 3B. At an excessively large offset amount, the heating temperature may differ between the front surface and the rear surface. In a vertical furnace, burners are arranged in the vertical direction, and flames 5 become unstable due to interference of the flames 5 injected from the burners on the downstream side (the furnace lower side) and the combustion gas, thereby degrading the stability and the temperature uniformity in the width and longitudinal directions of the steel sheet. In the case of circular burners, the interference of the flames 5 and the combustion gas can be moderated by forming a staggered pattern; however, in the case of slit burners, the influence of interference from the downstream side is intensified since there is no break in the flames 5 in the width direction. Thus, in the section where the slit burners are installed, a slit-shaped exhaust port 6 may be disposed under the slit burner for the purposes of letting the combustion exhaust gas from the downstream side escape therethrough. The combustion exhaust gas is preferably suctioned from the exhaust port 6 installed under the slit burner. As long as the line length and the heating capacity satisfy the required performance, the exhaust port 6 may be installed for each of the installed slit burners. Furthermore, as illustrated in FIG. 4, providing an exhaust port at each of the connecting portions of the burner groups also offers a sufficient effect. Specifically, combustion exhaust gas refers to high-temperature gas that is generated as a result of the reaction between the fuel and air and that contains, as main components, carbon dioxide, which is a reaction product, and nitrogen contained in water vapor and air as well as trace components such as unreacted excess fuel components, oxygen, and reaction intermediates.

Irrespective of the oxidation zone 1-1 or the reduction zone 1-2, the burner combustion rate is a value obtained by dividing the amount of the fuel gas actually introduced into the burner by the amount of the burner fuel gas at the maximum combustion load. When the burner is combusted at the maximum combustion load, the combustion rate is 100%. In accordance with aspects of the present invention, the combustion rate of the burner is not particularly limited; however, when the combustion load of the burner is low, a stable combustion state is no longer obtained and thus the combustion rate is preferably equal to or higher than the threshold described below. The predetermined threshold of the combustion rate is the ratio of the amount of the fuel gas at the lower limit of the combustion load at which the stable combustion state can be maintained relative to the amount of the fuel gas at the maximum combustion load. The threshold of the combustion rate differs depending on the burner structure, etc., and can be easily determined by performing a combustion test. Normally, the threshold is about 30%.

### <Air Ratios in Oxidation Zone and Reduction Zone>

Whether to perform or halt combustion can be freely selected for each of the burner groups 11 to 13 in the oxidation zone 1-1. For combustion, the combustion rate is preferably equal to or larger than the predetermined set value, and, in order to stably oxidize the steel sheet surface, the operation must be carried out in the oxidation zone 1-1 at an air ratio of 1 or more. Operation is preferably carried out at an air ratio of 1.00 or more in the oxidation zone 1-1. Operation is more preferably carried out at an air ratio of 1.05 or more and yet more preferably 1.10 or more in the oxidation zone 1-1. In order to prevent formation of excessive oxide films, generation of nitrogen oxides, and blowing out of the flames, operation is preferably carried out at an air ratio of less than 1.50 in the oxidation zone 1-1. Operation is more preferably carried out at an air ratio of 1.40 or less and yet more preferably 1.30 or less in the oxidation zone 1-1. The air ratio is the value obtained by dividing the amount of air actually introduced into the burner by the amount of air necessary to completely combust the fuel gas.

The slit burners of the burner group 14 in the reduction zone 1-2 need to be operated at an air ratio of less than 1, more preferably 0.70 or more and less than 1.00, and the combustion rate can also be controlled. When the burner group 14 in the reduction zone 1-2 is combusted at an air ratio of 0.70 or more and less than 1.00, the Fe oxides generated in the steel sheet surface are reduced and reduced Fe can be generated in the surface layer. Specifically, at an air ratio of less than 0.70, degradation of the fuel consumption rate and steel sheet contamination due to soot occur; meanwhile, when the air ratio is 1.00 or more, the oxygen concentration in the fuel gas is high, and the steel sheet is oxidized. The presence of the reduced Fe in the steel sheet surface layer portion prevents adhesion of the oxides to the rolls as the steel sheet S exited the direct fired furnace comes into contact with the rolls in the RT furnace, and thus can prevent defects (pickups) caused by oxide adhesion. To achieve this, the air ratio is preferably 0.70 or more. The air ratio is more preferably 0.75 or more and yet more preferably 0.80 or more. The air ratio is to be less than 1, preferably 0.95 or less, and more preferably 0.90 or less.

The number of burner groups to be combusted is determined by considering the heating load, the amount of formed oxides, etc., for various steel sheets S to be passed therethrough, and, for the burner groups to be combusted, the air ratio and the combustion rate are set to values within the aforementioned ranges. In this manner, the sheet temperature fluctuation in the steel sheet S travelling direction is decreased for various steel sheets S, and, for example, enough Fe oxides necessary to cause internal oxidation of Si can be generated stably in the travelling direction of the steel strip S. Decreasing the sheet temperature fluctuation in the steel sheet S travelling direction also contributes to stabilizing the oxide reducing action in the burner group 14 in the subsequent reduction zone 1-2, prevents insufficient reduction of the Fe oxides in the RT furnace, contributes to the internal oxidation of Si, and also contributes to suppressing adhesion of the oxides to the rolls in the RT furnace.

In this embodiment, the burner groups 11 to 13 in the oxidation zone 1-1 are oxidizing burners operated at an air ratio of 1.00 or more, the burner group 14 in the reduction zone 1-2 is reducing burners operated at an air ratio of less than 1.00, the regions heated by the burner groups 11 to 13 in the DFF oxidation zone 1-1 are the oxidation zone, and the region heated by the burner group 14 in the DFF reduction zone 1-2 is the reduction zone.

When the length of the reduction zone is small, the Fe oxide film remains in the surface layer, and the pickup preventing effect becomes insufficient. In contrast, when the length of the reduction zone is large, a surface concentration layer of Si and the like is formed in the steel sheet surface during the subsequent reduction annealing, and the coatability is impaired. Thus, the length of the reduction zone is preferably as follows.

The length (reduction zone length) of the burner group 14 in the reduction zone 1-2 in the steel sheet S travelling direction is preferably 150 mm or more and, in view of the uniformity in the width direction, is more preferably 300 mm or more. Yet more preferably, the length is 500 mm or more and most preferably 1000 mm or more. The upper limit of the length of the reduction zone is not particularly specified, but at an excessively large length, the heating amount ΔTrd in the reduction zone increases, and thus the heating amount ΔTox in the oxidation zone needs to be decreased. Such an excessively long reduction zone is disadvantageous for securing the oxidation amount, and thus the length is preferably 10 m or less. More preferably, the length is 5 m or less and still more preferably 3 m or less. This is also advantageous in terms of cost. The length of the burner group 14 in the reduction zone 1-2 in the steel sheet S travelling direction is the length (“L” in FIG. 1) of the steel sheet S heated region heated by the burner group 14, the region extending the burner most upstream and the burner most downstream in the burner group 14 in the reduction zone 1-2 in the steel sheet S travelling direction.

The oxidation zone length is preferably long enough to ensure the necessary amount of internal oxidation. However, since the oxidation amount changes according to the steel type to be passed, the temperature history, the sheet passing speed, and the steel sheet size, it is necessary to set the zone length to a length at which the necessary oxidation amount can be ensured even under the conditions least suitable for oxidation among production conditions.

In accordance with aspects of the present invention, the steel sheet S is oxidized and then reduced in the direct fired furnace 1. In particular, the oxidation amount formed in the oxidation zone must be precisely controlled in the steel sheet S travelling direction and width direction. In order to control the oxidation amount to an appropriate amount with respect to steel sheets of various steel types, temperature history, sheet passing speed, and size to be passed, the burners arranged to face the surface of the steel sheet S are preferably divided into at least two groups in the steel sheet S travelling direction and the combustion rate and the air ratio are preferably independently controllable group by group. In determining the burner group, slit burners and circular burners are preferably not mixed in one group but are preferably separated to be in separate groups and controlled separately.

Meanwhile, the action and effect intended in accordance with aspects of the present invention are still obtained even when the burners are controlled as one group in the reduction zone. Thus, in accordance with aspects of the present invention, the burners arranged to face the steel sheet surface in the oxidation zone 1-1 may be divided into two or more burner groups in the steel sheet S travelling direction so that the combustion rate and the air ratio can be independently controlled.

The thickness of the Fe oxide film formed in the oxidation zone 1-1 (oxidation zone 1-1 burner groups 11 to 13) changes depending on the Si content and the sheet thickness of the subject steel sheet and is preferably 100 to 500 nm. That is, when the thickness is less than 100 nm, the function as a barrier layer that inhibits diffusion and concentration of Si to the surface may become insufficient, and thus the thickness of the Fe oxide film is preferably 100 nm or more. The thickness of the Fe oxide film is more preferably 150 nm or more and yet more preferably 200 nm or more. Meanwhile, once the thickness exceeds 500 nm, the function as a barrier layer remains substantially unchanged, and there is a disadvantage of an increased fuel consumption due to a longer heating time in the oxidation zone 1-1; thus, the thickness of the Fe oxide film is preferably 500 nm or less. The thickness of the Fe oxide film is more preferably 450 nm or less and yet more preferably 400 nm or less.

The thickness of the reduced Fe formed in the reduction zone 1-2 (reduction zone 1-2 burner group 14) changes depending on the Si content and the sheet thickness of the subject steel sheet and is preferably 1 to 30 nm. That is, when the thickness is less than 1 nm, the pickup preventing effect may become insufficient, and thus the thickness of the reduced Fe is preferably 1 nm or more. The thickness of the reduced Fe is more preferably 5 nm or more and yet more preferably 10 nm or more. In contrast, once the thickness exceeds 30 nm, excessive reduced Fe occurs, and a surface concentration layer of Si and the like is formed in the steel sheet surface during the subsequent reduction annealing, thereby impairing the coatability. Thus, the thickness of the reduced Fe is preferably 30 nm or less. The thickness of the reduced Fe is more preferably 25 nm or less and yet more preferably 20 nm or less.

The thickness of the Fe oxide film and the thickness of the reduced Fe can be relatively easily estimated by monitoring the sheet temperature at the entry and the exit of the direct fired furnace 1 and performing correction on the basis of the steel type, the sheet thickness, the line speed, the air ratios in the oxidation zone 1-1 and reduction zone 1-2, and the combustion rates in the oxidation zone 1-1 and reduction zone 1-2. By adjusting mainly the combustion rates in the oxidation zone 1-1 and the reduction zone 1-2 on the basis of this value, stable oxidizing and reducing conditions can be determined and secured, and, as a result, a steel sheet free of bare spot defects can be obtained.

The steel sheet oxidized and reduced in the direct fired furnace 1 is then reduction-annealed in the RT furnace, cooled, and dipped in a hot-dip galvanizing bath to be hot-dip galvanized, and then subjected to an alloying treatment as necessary. The process of the reduction annealing and thereafter may be a typical process. The coating method is not particularly limited, and electrogalvanizing may be performed instead of the hot-dip galvanizing.

Since an appropriate amount of Fe oxides are formed and then the surface layer is reduced to generate reduced Fe in the direct fired furnace 1 and since the Fe oxides are all reduced and Si is internally oxidized in the subsequent reduction annealing step, adhesion of the oxides to the rolls can be prevented. Thus, press marks caused by roll pickups, Si surface layer concentration, and coating defects caused by insufficient reduction of Fe oxides do not occur.

The hot-dip galvanized steel sheet to be produced in accordance with aspects of the present invention is effective when large amounts of metal elements, such as Si, more easily oxidizable than Fe are contained. Specifically, it is suitable for producing a high-Si-content hot-dip galvanized steel sheet containing 0.1 to 3.0 mass % of Si.

### EXAMPLES

A CGL was equipped with a direct fired furnace (DFF) 1 that included four burner groups 11 to 14 of heating burners, in which three burner groups 11 to 13 disposed on the upstream side in the steel strip S travelling direction were placed in the oxidation zone 1-1, and the last one burner group 14 was placed in the reduction zone 1-2. Furthermore, a test was conducted separately for two cases: the case where the air ratio and the combustion rate were individually controlled for each of the burner groups in the oxidation zone 1-1 and the case where the burner groups 11 to 13 in the oxidation zone were collectively controlled by using the same conditions. FIG. 1 illustrates one example of the burner arrangement. In FIG. 1, flame injection ports 3 associated with circular burners were disposed in the burner groups 11 to 13 in the oxidation zone, and the flame injection ports 2 associated with slit burners were disposed in the burner group 14 in the reduction zone. The test was conducted by changing the burner type according to the conditions for each of the burner groups. Gas having a composition indicated in Table 1 was used as the fuel gas for the burners. The length of each burner group (“L” in FIG. 1) was 3 m, and the slit gap B was 20 mm.

The steel chemical composition of the steel strip S used in the test is indicated in Table 2.

Other test conditions were as follows: sheet thickness: 1.0 mm, sheet width: 1000 mm, the DFF entry side average sheet temperature: 200° C., DFF exit side average temperature: 650° C., annealing temperature in RT furnace: 850° C., coating bath temperature: 463° C., coating Al concentration: 0.135%, alloying temperature: 550° C. Speed of the steel strip S (LS) was examined in three levels: 60 mpm, 90 mpm, and 120 mpm.

The roll mark defect (pickup) caused by excessive oxidation was evaluated, and the quality deviation for the coating appearance was evaluated in the travelling direction and the width direction. In any of the tests, the ratings A and B indicate pass, and the rating C indicates fail.

The same techniques as the method disclosed in Patent Literature 5 below were used. The roll mark defect (pickup) caused by excessive oxidation was inspected with an optical surface defect meter in a 1 m² field of view of a surface of a steel sheet selected at random. The aforementioned surface defect meter can detect marks with a diameter of 0.5 mm or more, and the detected marks were assumed as depression defects caused by contacting the pickups, in other words, roll mark defects.
[Patent Literature 5] Japanese Patent No. 6607339
A (good): Zero per 1 m² (no roll mark defect occurred)
B (fair): 1 or 2 defects per 1 m² (minor roll mark defects were observed)
C (poor): 3 or more defects per 1 m² (roll mark defects were present)

The coating appearance was evaluated by measuring the variation in the Fe concentration (indicator of the alloying rate) in the coating in the steel sheet surface after the alloying treatment with respect to the target value. The smaller the variation with respect to the target value of the Fe concentration in the coating, the better the rating of the coating appearance. Here, the Fe concentration was measured by the same technique as the method described in Patent Literature 6 below, which is an X-ray diffraction method in which the Fe concentration was calculated from the change in diffraction peak angle of the alloying phase constituting the coating layer.
[Patent Literature 6] Japanese Patent No. 5962615
A (good): Less than +0.5% (bare spot or alloying variation was not found)
B (fair): Less than +1% (minor bare spot and/or minor alloying variation was found)
C (poor): 1% or more (prominent bare spot and/or prominent alloying variation was found)
The ratings A and B indicate pass, and the rating C indicates fail.

Furthermore, a 1000 mm-long sample was taken in the width direction from each of three selected places in the travelling direction, that is, the tip portion, the center portion, and the end portion of the steel strip S, and was evaluated for the roll mark and the coating appearance at the width center portion thereof, and the obtained results were used to evaluate the quality in the travelling direction.

In addition, a width×1000 mm sample was taken from the center portion of the steel strip S, and, in this sample, five points, i.e., the center point in the width direction, the ¼-width and ¾-width points, and two end points, were evaluated for the roll mark and the coating appearance. The obtained results were used to evaluate the quality in the width direction.
⊚: Only the rating A was given in the evaluation of roll mark and coatability under the same conditions.
∘: The rating of A or B was given in the evaluation of roll mark and coatability under the same conditions.
Δ: Only the rating B was given in the evaluation of roll mark and coatability under the same conditions.
x: The rating C was included in the evaluation of roll mark and coatability under the same conditions.

A sample that is evaluated as pass in accordance with aspects of the present invention is the one that was not rated C for any of the roll mark defect and the coating appearance but was rated ⊚, ∘, and/or Δ in the width direction and the travelling direction. A sample that was rated Δ or higher in both the width direction and the travelling direction was rated pass (∘) and a sample that included the rating x was rated fail (x).

Condition Nos. 1 to 7 were produced under the condition that the line speed of the steel strip S was 60 mpm. Condition 1 is a conventional type in which circular burners were used in the reduction zone burner group 14 (comparative example). The reducing power did not stabilize in the width direction and the travelling direction, the roll mark defects caused by excessive oxidation were observed, and the sample was rated fail. Condition 2 is an example according to aspects of the present invention in which slit burners were used in the reduction zone burner group 14 instead of circular burners. Since the burner flames were uniform in the width direction and reduced Fe was obtained uniformly in the width direction and the travelling direction, a stable quality steel strip S free of roll mark defect caused by excessive oxidation was obtained. In condition 3, although slit burners were used, the air ratio in the oxidation zone was 0.90, and the coating appearance was poor due to insufficient oxidation power. Condition 4 is the case in which the air ratio in the oxidation zone was excessive in contrast to condition 3. The surface quality was more stable than condition 3 and the sample was rated pass. In condition 5, although slit burners were used as in conditions 2 and 3, the air ratio in the reduction zone was as high as 1.00, and thus the roll mark defect was observed. Condition 6 is the case in which the air ratio in the reduction zone was low compared to condition 5. The surface defects decreased compared to condition 5 and the sample was rated pass. Condition 7 is an example in which the air ratio in the reduction zone was adjusted to further decrease the combustion rate in the reduction zone. The surface defects decreased compared to condition 5 and the sample was rated pass.

Conditions 8 to 9 were examples in which the line speed of the steel strip S was 90 mpm. In condition 8, circular burners were used in the reduction zone burner group 14, and the quality was poor as in condition 1 and the sample was rated fail. In contrast, condition 9 in an example in which slit burners were used. As a result, the surface quality improved compared to condition 8, and the sample was rated pass.

Conditions 10, 11, and 12 were examples in which the line speed of the steel strip S was 120 mpm. In condition 10, since circular burners were used as in conditions 1 and 8, the surface quality was rated fail. In condition 11, slit burners were used, and, as in condition 9, the surface quality improved and stabilized, and the sample was rated pass. Condition 12 is an example in which slit burners were used in both the oxidation zone and the reduction zone. As a result, the surface quality was stable at a high level.

Condition 13 is an example in which slit burners were used in a heating zone of a horizontal furnace. Of the four burner groups constituting the heating zone, the most downstream burner group 14 was operated as a reduction zone with an air ratio of less than 1. Since the furnace was a horizontal furnace, the production efficiency was low compared to other examples, but the defect level was maintained low, and the sample was rated pass. However, since the furnace was a horizontal furnace, the atmosphere separation between the heating zone and the soaking zone became insufficient, and the uniformity in the width direction and the travelling direction was degraded.

Condition 14 is an example in which an exhaust port was installed upstream of the burner group in which slit burners were used in contrast to condition 2. Since the exhaust port was installed, interference between flames was avoided, the uniformity in the width direction and the travelling direction was further improved, and the surface quality stabilized at a high level.

The aforementioned results confirmed that by using slit burners in the reduction zone, the surface quality is improved, and by optimizing the control method and the combustion conditions, better surface quality is obtained.

TABLE 1
(Unit: vol %)

| CO₂ | H₂O | CO | N₂ | H₂ | O₂ | CH₄ | C₂H₄ |
|---|---|---|---|---|---|---|---|
| 2.7 | 0 | 7.5 | 5.9 | 56.5 | 0.2 | 25.0 | 2.2 |

TABLE 2
(Unit: mass %)

| C | Si | Mn | P | S | Cu | Al | Cr | Mo | Nb | N |
|---|---|---|---|---|---|---|---|---|---|---|
| 0.12 | 1.50 | 1.25 | 0.013 | 0.04 | Tr | Tr | Tr | Tr | 0.033 | 0.001 |

TABLE 3

| | | | Oxidation zone | | | | | | | | | |
|---|---|---|---|---|---|---|---|---|---|---|---|---|
| | | | Burner group 11 | | | | | Burner group 12 | | | | |
| | | | Entry side | | | | | Entry side | | | | |
| | | | average | | | | | average | | | | |
| | | | sheet | | | | | sheet | | | | |
| | | | temper- | | Air | | | temper- | | Air | | |
| Condition | LS | Furnace | ature | Burner | ratio | Combustion | Exhaust | ature | Burner | ratio | Combustion | Exhaust |
| No. | [mpm] | type | [° C.] | type | [—] | rate [%] | port | [° C.] | type | [—] | rate [%] | port |
| 1 | 60 | Vertical | 201 | Circular | Not used | | None | 203 | Circular | Not used | | None |
| 2 | 60 | Vertical | 199 | Circular | Not used | | None | 204 | Circular | Not used | | None |
| 3 | 60 | Vertical | 201 | Circular | Not used | | None | 203 | Circular | Not used | | None |
| 4 | 60 | Vertical | 202 | Circular | Not used | | None | 204 | Circular | Not used | | None |
| 5 | 60 | Vertical | 198 | Circular | Not used | | None | 202 | Circular | Not used | | None |
| 6 | 60 | Vertical | 198 | Circular | Not used | | None | 203 | Circular | Not used | | None |
| 7 | 60 | Vertical | 198 | Circular | Not used | | None | 202 | Circular | Not used | | None |
| 8 | 90 | Vertical | 199 | Circular | Not used | | None | 202 | Circular | 1.10 | 49 | None |
| 9 | 90 | Vertical | 200 | Circular | Not used | | None | 203 | Circular | 1.10 | 49 | None |
| 10 | 120 | Vertical | 201 | Circular | 1.05 | 32 | None | 274 | Circular | 1.15 | 50 | None |
| 11 | 120 | Vertical | 200 | Circular | 1.10 | 32 | None | 273 | Circular | 1.15 | 50 | None |
| 12 | 120 | Vertical | 200 | Slit | 1.10 | 32 | None | 273 | Slit | 1.15 | 50 | None |
| 13 | 30 | Horizontal | 405 | Slit | 1.10 | 24 | None | 450 | Slit | 1.15 | 24 | None |

| | | | | | | | | | | |
|---|---|---|---|---|---|---|---|---|---|---|
| 14 | 60 | Vertical | 199 | Circular | Not used | None | 204 | Circular | Not used | Present |

| | Oxidation zone | | | | | Reduction zone | | | |
|---|---|---|---|---|---|---|---|---|---|
| | Burner group 13 | | | | | Burner group 14 | | | |
| | Entry side | | | | | Entry side | | | |
| | average | | | | | average | | | |
| | sheet | | | | | sheet | | | |
| | temper- | | Air | | | temper- | | Air | |
| Condition | ature | Burner | ratio | Combustion | Exhaust | ature | Burner | ratio | Combustion |
| No. | [° C.] | type | [—] | rate [%] | port | [° C.] | type | [—] | rate [%] |
| 1 | 285 | Circular | 1.05 | 72 | None | 553 | Circular | 0.80 | 50 |
| 2 | 280 | Circular | 1.05 | 72 | None | 550 | Slit | 0.80 | 50 |
| 3 | 281 | Circular | 0.90 | 72 | None | 499 | Slit | 0.90 | 50 |
| 4 | 283 | Circular | 1.60 | 72 | None | 501 | Slit | 0.90 | 50 |
| 5 | 282 | Circular | 1.10 | 72 | None | 550 | Slit | 1.00 | 50 |
| 6 | 286 | Circular | 1.10 | 72 | None | 542 | Slit | 0.65 | 50 |
| 7 | 282 | Circular | 1.10 | 96 | None | 592 | Slit | 0.85 | 25 |
| 8 | 378 | Circular | 1.10 | 59 | None | 550 | Circular | 0.90 | 75 |
| 9 | 378 | Circular | 1.10 | 59 | None | 498 | Slit | 0.90 | 75 |
| 10 | 389 | Circular | 1.10 | 70 | None | 550 | Circular | 0.85 | 100 |
| 11 | 388 | Circular | 1.15 | 70 | None | 550 | Slit | 0.85 | 100 |
| 12 | 388 | Slit | 1.15 | 70 | None | 550 | Slit | 0.85 | 100 |
| 13 | 490 | Slit | 1.15 | 24 | None | 530 | Slit | 0.85 | 20 |
| 14 | 280 | Slit | 1.05 | 72 | Present | 550 | Slit | 0.80 | 50 |

| | DFF | | | | | | |
|---|---|---|---|---|---|---|---|
| | exit side | Excessive | | | | | |
| | average | oxidation | | | | | |
| | sheet | defects | | | | | |
| | temper- | (roll | | Width | Longitudinal | | |
| Condition | ature | marks | Coating | direction | direction | | |
| No. | [° C.] | etc.) | appearance | quality | quality | Rating | Remarks |
| 1 | 648 | C | C | X | X | X | Comparative |
| | | | | | | | Example |
| 2 | 650 | A | A | ⊚ | ◯ | ◯ | Example |
| 3 | 650 | A to B | C | ◯ | X | X | Comparative |
| | | | | | | | Example |
| 4 | 652 | B | B | Δ | Δ | ◯ | Example |
| 5 | 650 | C | B | Δ | X | X | Comparative |
| | | | | | | | Example |
| 6 | 658 | B | B | Δ | Δ | ◯ | Example |
| 7 | 650 | B | B | Δ | Δ | ◯ | Example |
| 8 | 652 | B to C | C | X | Δ | X | Comparative |
| | | | | | | | Example |
| 9 | 649 | A | A | ⊚ | ◯ | ◯ | Example |
| 10 | 648 | C | B to C | X | Δ | X | Comparative |
| | | | | | | | Example |
| 11 | 652 | A to B | A | ⊚ | ◯ | ◯ | Example |
| 12 | 652 | A | A | ⊚ | ⊚ | ◯ | Example |
| 13 | 570 | A to B | B | Δ | Δ | ◯ | Example |
| 14 | 650 | A | A | ⊚ | ⊚ | ◯ | Example |

### REFERENCE SIGNS LIST

1 direct fired furnace (DFF)
1-1 oxidation zone
1-2 reduction zone
2 flame injection port associated with slit burner
3 flame injection port associated with circular burner
4 radiation thermometer
5 flame
6 exhaust port
S steel sheet (steel strip)
L length of a steel strip region heated by a burner group 14 from a burner most upstream to a burner most downstream in the burner group in the steel strip travelling direction
11 burner group in oxidation zone
12 burner group in oxidation zone
13 burner group in oxidation zone
14 burner group in reduction zone
B slit gap
20 preheating zone
21 heating zone (direct firing heating)
22 soaking zone
23 cooling zone
24 cooling zone
25 coating bath (zinc pot)
26 alloying zone
27 cooling zone

1. A method for heating a steel sheet, the method comprising heating a front surface side and a rear surface side of a steel sheet that is passing through a direct fired furnace that has an oxidation zone where operation is conducted at an air ratio of 1 or more and a reduction zone where operation is conducted at an air ratio of less than 1, wherein the heating is carried out with flames injected from at least one slit burner extending in a width direction of the steel sheet while the steel sheet passes through at least the reduction zone.

2. The method for heating a steel sheet according to claim 1, wherein the direct fired furnace conveys the steel sheet in a vertical direction and suctions combustion exhaust gas from an exhaust port installed under the slit burner.

3. The method for heating a steel sheet according to claim 1, wherein the air ratio in the oxidation zone is controlled to 1.00 or more and less than 1.50, and
the air ratio in the reduction zone is controlled to 0.70 or more and less than 1.00.

4. A method for producing a coated steel sheet, the method comprising heat-treating a cold rolled steel sheet by the heating method according to claim 1, and subjecting the cold rolled steel sheet to a coating treatment.

5. The method for producing a coated steel sheet according to claim 4, wherein the coating treatment uses one of an electrogalvanizing treatment, a hot-dip galvanizing treatment, and a galvannealing treatment.

6. A direct fired furnace including:
an oxidation zone where operation is conducted at an air ratio of 1 or more, a reduction zone where operation is conducted at an air ratio of less than 1, and a control device capable of controlling the air ratios in the oxidation zone and the reduction zone,
wherein at least one portion of the reduction zone is equipped with:
at least one slit burner disposed on a front surface side of the steel sheet and at least one slit burner disposed on a rear surface side of the steel sheet, each of the slit burners extending in a width direction of the steel sheet and injecting flames toward the steel sheet passing through the oxidation zone and the reduction zone.

7. The direct fired furnace according to claim 6, wherein the steel sheet is conveyed in a vertical direction, and combustion exhaust gas is suctioned from exhaust ports installed under the slit burners.

8. The direct fired furnace according to claim 6,
wherein the air ratio in the oxidation zone is controlled to 1.00 or more and less than 1.50, and
the air ratio in the reduction zone is controlled to 0.70 or more and less than 1.00.

9. A continuous hot-dip galvanizing facility comprising the direct fired furnace according to claim 6.

10. The continuous hot-dip galvanizing facility according to claim 9, further comprising an alloying facility that alloys hot-dip galvanized coatings.
